(19) United States
(12) Patent Application Publication
(10) Pub. No.: US 2005/0042571 A1
(43) Pub. Date: Feb. 24, 2005

(54) Dental compound dispenser

(76) Inventor: Kevin W. Calvert, San Jose, CA (US)

Correspondence Address: Michael A. Guth, 2-2905 East Cliff Drive, Santa Cruz, CA, 95062, US

(21) Appl. No.: 10/643,096

(22) Filed: Aug. 18, 2003

(51) Int. Cl. A61C 3/00; A61C 1/12

(52) U.S. Cl. 433/31; 433/82

(57) ABSTRACT

A dispenser for a tooth cleaning compound which mounts to a dental implement, such as a retraction tool or dental mirror, in the hand opposite that which holds the dental handpiece with the prophy angle and prophy cup. The dispenser may be disposable and meant for one use only, or may instead allow for the mounting of a disposable paste reservoir.

### BACKGROUND OF THE INVENTION

1. Field of the Invention

This invention is in the field of dispensers and is specifically directed to the field of dental teeth cleaning apparatus.

This invention relates to the dispensing of a fluid, such as a dental cleaning compound, from a handheld dental instrument. A fluid such as a prophylactic paste is dispensed from an attachable dispenser coupled to a retraction tool or dental mirror, allowing for the application of the paste to a prophylactic cup without necessitating the complete withdrawal of the prophylactic cup from the mouth area.

2. Description of Related Art

Application of a fluid cleaning agent such as a prophylactic paste to a patient's teeth by an oral hygienist or a dentist is a common part of teeth cleaning.

Typically, a prophy cup mounted on the end of a headpiece is dipped into a prophylactic paste filled container to fill the cup. A portion of the headpiece and possibly a portion of the handpiece is placed in the patient's mouth while the prophy cup is pressed against the patient's teeth. The prophy cup is rotated, usually by a system of gears in the headpiece that is coupled to a pneumatic actuation mechanism in the instrument handpiece. The paste is used rapidly, thus the prophy cup must be withdrawn from the patient's mouth and returned to the paste container often for refilling. Often the paste container is attached to an apparatus held on a finger or between the fingers of the hand of the hygienist or dentist that is not holding the cleaning handpiece. An example of such a device is seen in U.S. Pat. No. 5,048,731 to Moreschini.

Efforts have been made in the prior art to simplify the cleaning process. Such efforts include paste containers integrated with the prophy angle headpiece, and an apparatus for delivering paste from the container to the prophy cup or to from such apparatus directly to the teeth. An example of such an apparatus is seen in U.S. Pat. No. 4,220,446 to Walker. In this instance, a paste dispenser is mounted on the handpiece holding the prophy angle itself. The tooth cleaning agent is dispensed through the use of a pneumatic mechanism that ultimately dispenses the tooth cleaning agent from a tube adjacent to the prophy cup. A drawback of this device is that it is meant to be reuasable. Modern hygiene and disease control protocols may discourage the reuse of portions of cleaning apparatus that are to enter the patient's mouth. In addition, the location of a dispensing tube near the prophy cup can interfere with the tooth cleaning process by limiting the free motion of the prophy cup within the patient's mouth. Although a disposable prophy angle with a built in dispenser to the prophy cup may solve this problem, it carries the distinct disadvantage of requiring the replacement of the prophy angle and prophy cup upon the exhaustion of the reservoir of dental cleaning compound.

During the cleaning of teeth, the hand opposite that which holds the dental handpiece with the prophy angle and cup usually holds a retraction tool, often a dental mirror. The retraction tool is used to move the patient's lip and mouth away from the tooth area being cleaned. The retraction tool is also used to change the position of the tongue such that it does not interfere with the cleaning process. The handle of this retraction tool often is either round or octagonal. It may be serrated or knurled to allow for better gripping by the hand of the dentist or hygienist. If a dental mirror is used, it can also provide an additional viewing angle for the dentist or hygienist. This hand opposite, which holds the retraction tool or dental mirror is a stabilizing force for the patient's mouth and jaw during the tooth cleaning process.

The prophy cup is often at work very close to the retraction tool or dental mirror. What is called for is a dispenser for the dispensing of dental cleaning paste which is close to the area in which the dentist or hygienist is working yet does not interfere with the prophy angle and cup during the cleaning of the teeth. A dental cleaning paste dispenser adapted to mount to the retraction tool or dental mirror held in the hand opposite that which holds the dental handpiece with the prophy angle and prophy cup fills this need.

### BRIEF SUMMARY OF THE INVENTION

The present invention is a dispenser for a tooth cleaning paste which mounts to a dental implement, such as a retraction tool or dental mirror, in the hand opposite that which holds the dental handpiece with the prophy angle and prophy cup. The dispenser may be disposable and meant for one use only, or may instead allow for the mounting of a disposable paste reservoir. The dispenser may clip onto the handle of the retraction tool, may slide onto the handle of the retraction tool, or may be attached using other means. A goal of the invention is to allow for the refilling of the prophy cup during a tooth cleaning process with good efficiency of the movement of the hands of the dentist or dental hygienist.

### BRIEF DESCRIPTION OF THE DRAWINGS

FIG. 1 is a pictorial view of a dental handpiece with a prophy angle and prophy cup.

FIG. 2 is a cross-sectional representation of a prophy angle head and prophy cup.

FIG. 3 is a pictorial view of a dental mirror.

FIGS. 4A-D are pictorial views of one embodiment of the present invention.

FIGS. 5A-C are pictorial views of another embodiment of the present invention.

FIGS. 6A-B are pictorial views of another embodiment of the present invention.

### DETAILED DESCRIPTION OF THE INVENTION

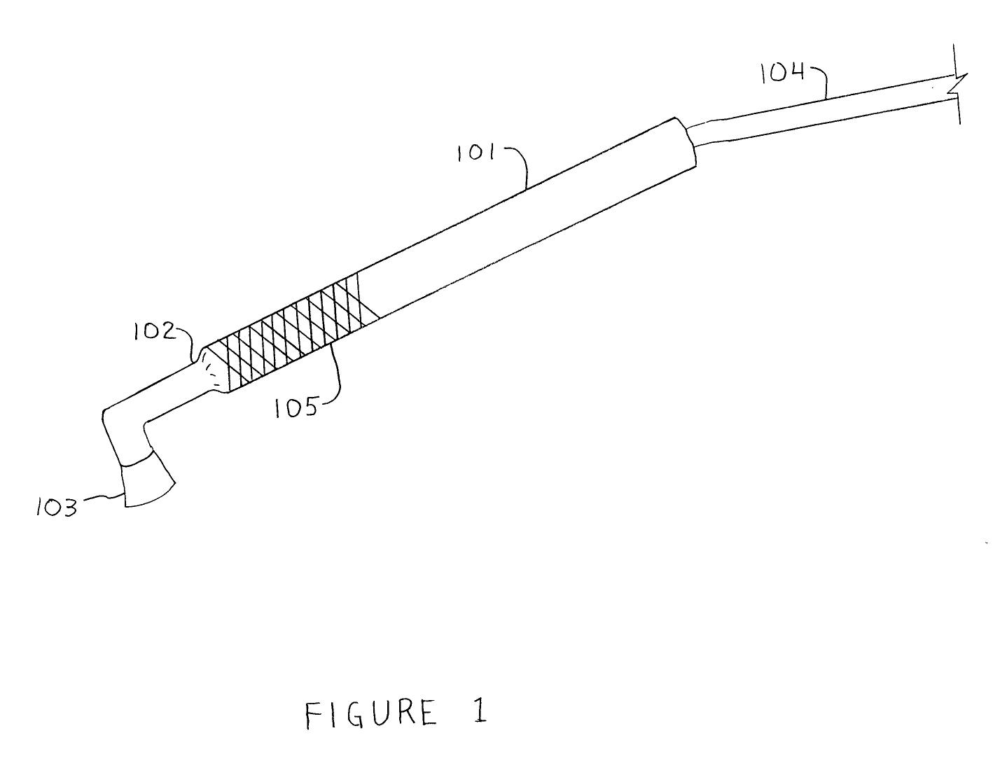

As seen in FIG. 1, dental handpiece 101 is used as a mount for and to provide rotational driving force to prophy angle 102. Dental handpiece 101 may be fashioned from metal and may include a knurled region 105 to allow for better gripping by the dentist or dental hygienist. Dental handpiece 101 may be pneumatically driven, and in that case would include air hoses 104. Other dental handpieces may be mechanically driven using a variety of gears, pulleys, and cables. Dental handpiece 101 may be used to support and drive prophy angle 102. Prophy angle 102 has prophy cup 103 mounted on its end opposite the end of the prophy angle 102 mounted to dental handpiece 101. In operation, prophy cup 103 is rotated and applied to a tooth surface. This rotation is used to displace a cleaning paste using the rotation of prophy cup 103 and the pressure applied to the tooth from the hand of the operator applied when held generally by knurled region 105.

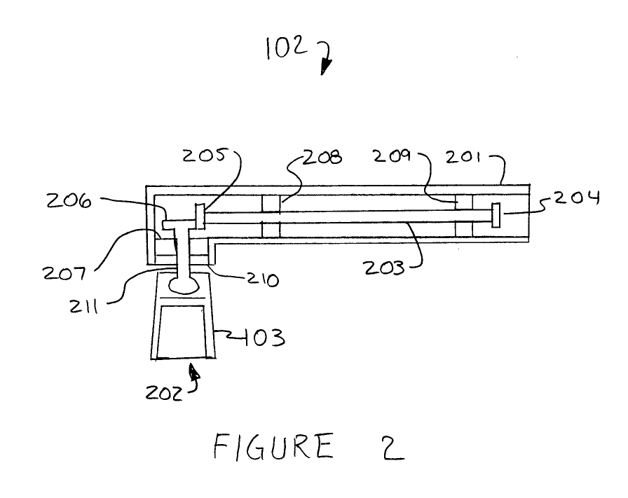

As seen in cross section in FIG. 2, prophy angle 102 transfers kinetic motion from the dental handpiece to the prophy cup 103. Cleaning paste or other compounds are placed in prophy cup 202, which is then placed on a tooth surface. In some embodiments, drive gear 204 is driven from a mating gear in the dental handpiece 101. Drive gear 204 is used to rotate shaft 203. Shaft 203 is supported by bushings 208, 209 in some embodiments. Gear 205 is attached to the far end of shaft 203 and transfers motion to shaft 211 via gear 206. Shaft 211 may be supported by bushing 207 in some embodiments. Shaft 211 protrudes out of the prophy angle housing 201 and is engaged to and supports prophy cup 103. In some embodiments, prophy angle 102 is made primarily of plastic and is meant for a single use only. Prophy angle 102 may be composed of metal or other suitable materials.

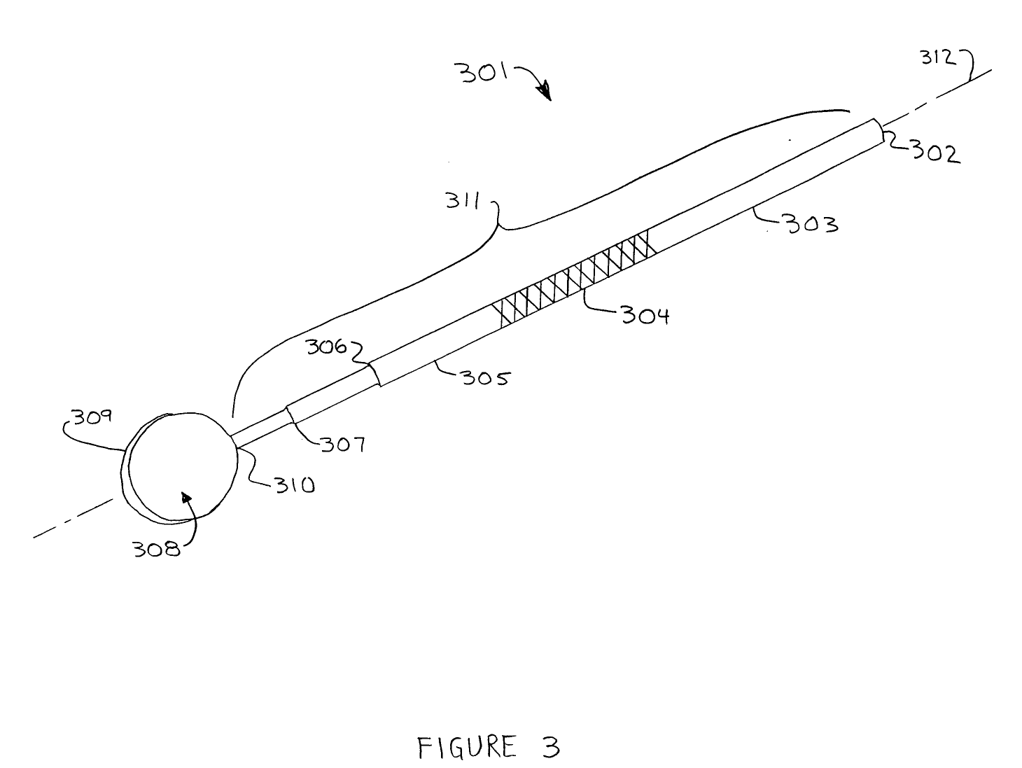

FIG. 3 is a pictorial representation of a dental mirror 301. Dental mirror 301 is used to gain an additional viewpoint of objects in a dental patient's mouth. In addition, dental mirror 301 is used to hold the lips of the dental patient to allow for better access of the prophy cup 103 to the patient's teeth. Dental mirror 301 has a handle portion 311 which is generally made of a metal such as a stainless steel. Handle portion 311 is generally composed of upper handle portion 303 which is the first portion of the shaft below end 302. Central handle portion 304 is knurled in some embodiments. Lower handle portion 305 may be of the same outside diameter as upper handle portion 303. In some embodiments, lower handle portion 305 is of a smaller outside diameter than upper handle portion 303. In some embodiments, handle portion 311 is octagonal in cross section or may have other cross sectional profiles.

In some embodiments of dental mirror 301, a sudden neckdown 306 of the outside diameter occurs below lower handle portion 305. In addition, other outside diameter changes 307 may occur. A circular mirror 308 is mounted to mirror backing plate 309 in some embodiments. Mirror backing plate 309 is attached to handle portion 311 at attach point 310. In some embodiments, handle portion 311 is bent slightly at attach point 310 to allow for a better viewing angle while dental mirror 301 is in use during dental operations. Dental mirror 301 is generally configured around a principal axis 312 which is coincident with the center of handle 311. Mirror backing plate 309 may be detachable from handle portion 311.

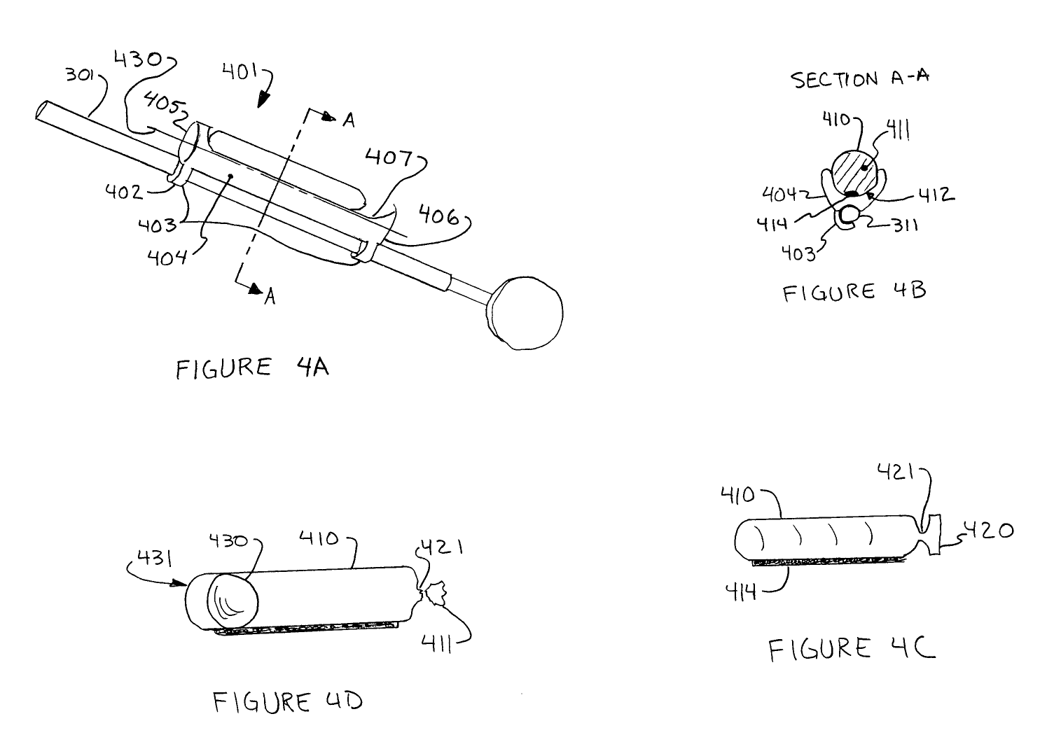

In some embodiments of the present invention, as seen in FIG. 4A, dental compound cleaning dispenser 401 is attached to dental mirror 301 by attachment portion 402. In some embodiments, attachment portion 402 is made up of two or more elastic clips 403 which are coupled to the main body 404 of dental cleaning compound dispenser 401 at or near opposite ends 405, 406. In some embodiments, only one clip is used. In some embodiments, main body 404 has an orifice 407 within which dental cleaning compound will deposit upon actuation of the dispenser. Orifice 407 may be an opening in the main body 404 along principal axis 430 at end 406 or may open out at another angle. In some embodiments, principal axis 430 is predominantly parallel to dental mirror principal axis 312. Prophy cup 103 may be dipped into orifice 407 in order to transfer additional cleaning compound to prophy cup 103.

Clips 403 and main body 404 may be made of plastic or rubberized compounds in some embodiments. Clips 403 are able to deflect outwardly from main body 404 to accommodate shaft portion 311 of dental mirror 301. Clips 403 maintain sufficient grip on shaft 311 of dental mirror 301 such that dispenser 401 is mounted snugly on shaft portion 311. In some embodiments, dispenser 401 may be attached to dental mirror 301 by inserting shaft end 302 into the opening formed by clips 403 and sliding dispenser 401 along shaft portion 311 to an appropriate location. Although a dental mirror has been used to illustrate the retraction tool in this embodiment, one of skill in the art will understand that other retraction tools may be used with this invention.

In some embodiments, as seen in FIG. 4B, main body 404 has a reservoir 412 within it. Reservoir 412 may be a recess in the main body 404. In some embodiments, reservoir 412 is adapted to receive compound container 410. Compound container 410 may be filled with dental cleaning compound 411. In some embodiments, compound container 410 may be removable and replaceable. In some embodiments, compound container 410 may have an adhesive strip 414 adhered to one side along its length. Adhesive strip 414 allows for the placement of a removable compound container 410 into reservoir 410 and secures sufficiently to allow for the dispensing of cleaning compound 411 without dislodging compound container 410.

In some embodiments, as shown in FIG. 4C, compound container 410 may have a neckdown 421. Once compound container 410 is adhered into reservoir 414, end 420 may be removed by tearing or other methods. In some embodiments, cleaning compound 411 may be forced from compound container 410 by pressing onto the external surface of compound container 410. In some embodiments, cleaning compound 411 may be forced into orifice 407. Prophy cup 103 may then be dipped into cleaning compound 411 which has been forced into orifice 407 to allow for the continuation of tooth cleaning by the dentist or dental hygienist.

In some embodiments, as seen in FIG. 4D, compound container 410 contains ball 430. Ball 430 is embedded within compound container 410 in the end opposite neckdown 421. By pushing with a finger or other implement behind ball 430 at end 431, the dentist or dental hygienist forces out cleaning compound 411.

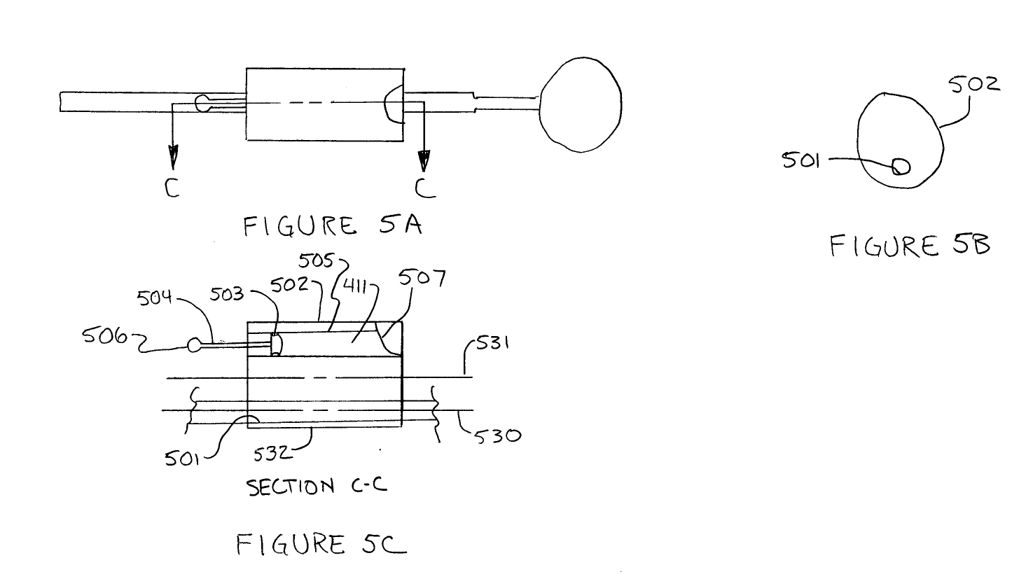

In some embodiments, as seen in FIG. 5A, dispenser 502 may mount onto dental mirror handle 301 by sliding down over the dental mirror handle 301. In some embodiments, main body 532 has a principal axis 531. Dispenser 502 has annulus 501 within it. Annulus 501 has a principal axis 530. In some embodiments, the principal axis 531 of main body 532 is substantially parallel to principal axis 530 of annulus 501. Annulus 501 is sized such that it snugly and firmly grips onto dental mirror handle 301 when slid down upon it. Main body 502 may be used by the dentist or dental hygienist to grip the retraction toll in some embodiments. In some embodiments, as seen in FIG. 5B, annulus 501 is off center from the center of dispenser 502. In some embodiments, annulus 502 may be down the center of dispenser 502. In such a case, principal axis 530 and principal axis 531 are coincident. Although a dental mirror has been used to illustrate the retraction tool in this embodiment, one of skill in the art will understand that other retraction tools may be used with this invention.

In some embodiments, as seen in FIG. 5C, dispenser 502 includes dental compound reservoir 505 which contains cleaning compound 411. Plunger 504 pushes stopper 503 when pushed on its end 506 by the dentist or dental hygienist. When plunger 504 is pushed upon, dental cleaning compound 411 is pushed out into orifice 507, where the prophy cup 103 may then be dipped in order to replenish the cleaning compound used for a tooth cleaning operation.

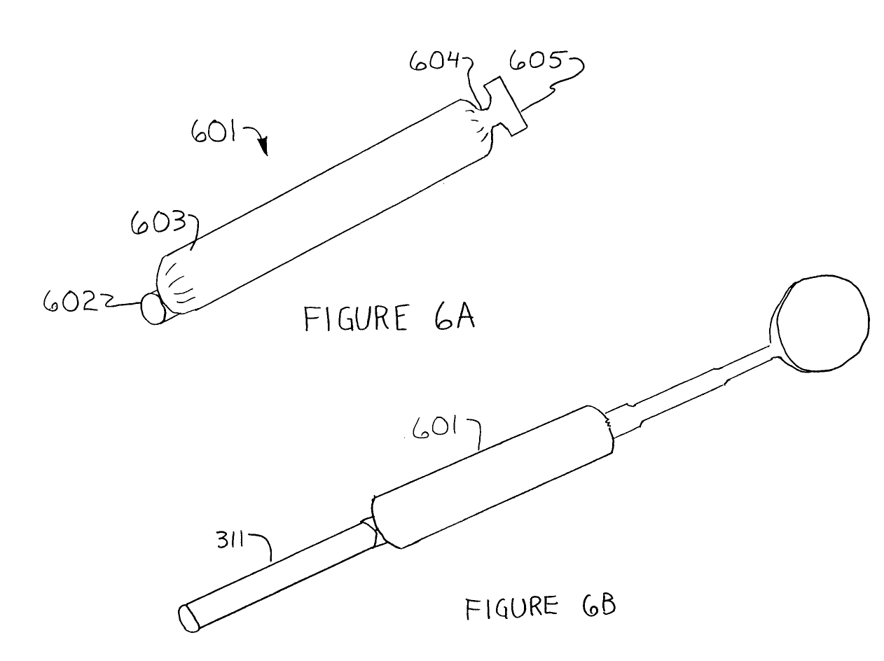

In some embodiments, as seen in FIG. 6A, dispenser 601 includes annulus 602 which is disposed to slide over handle 311 of dental mirror 301. Main body 601 may include neckdown 604, which provides an opening for the dispensing of cleaning compound 411. The opening is made once tear tab 605 is torn, which creates the opening at neckdown 604.

As seen in FIG. 6B, dispenser 601 is mounted on handle 311, allowing for the dispensing of a compound.

It should be understood that the embodiments disclosed may be combined in various combinations and still be within the confines of the present invention.

1. A dental compound dispenser, said dental compound dispenser comprising: a main body assembly, said main body assembly comprising:
a main body portion, wherein said main body portion is predominantly configured about a first principal axis,
an attachment portion, said attachment portion coupled to said main body portion, said attachment portion disposed to attach to a retraction tool handle, and a compound reservoir, said compound reservoir coupled to said main body portion.

2. The dental compound dispenser of claim 1, further comprising a compound dispenser.

3. The dental compound dispenser of claim 2, further comprising a compound container disposed predominantly within said compound reservoir.

4. The dental compound dispenser of claim 3, further comprising dental cleaning compound, wherein said dental cleaning compound is contained primarily within said compound container.

5. The dental compound dispenser of claim 1 wherein said attachment portion comprises two or more elastic clips.

6. The dental compound dispenser of claim 1 wherein said attachment portion comprises an annulus within said main body portion, wherein said annulus has a second principal axis that is substantially parallel to said first principal axis.

7. The dental compound dispenser of claim 3, wherein said compound container is adhered to said compound reservoir with adhesive.

8. The dental compound dispenser of claim 5, wherein said elastic clips are fashioned to attach to a cylinder of less than 0.3 inches diameter.

9. The dental compound dispenser of claim 1, wherein said retraction tool is a dental mirror.

10. The dental compound dispenser of claim 1, wherein said attachment portion is coupled to said main body portion in such a manner that the main body portion can be attached to said retraction tool handle such that the main axis of the retraction tool handle is substantially coaxial to said first principal axis.

11. A dental compound dispenser, said dental compound dispenser comprising: a main body assembly, said main body assembly comprising:
a main body portion,
an attachment portion, said attachment portion disposed to attach to a retraction tool handle, said attachment portion coupled to said main body portion, and
a compound container, said compound container within said main body portion.

12. A dental compound dispenser, said dental compound dispenser comprising an attachment portion, said attachment portion disposed to attach to a retraction tool handle, said attachment portion coupled to a compound reservoir, and a compound reservoir.

13. The dental compound dispenser of claim 12, wherein said attachment portion comprises an annulus.

14. The dental compound dispenser of claim 12, wherein said attachment portion comprises one or more elastic clips.

15. The dental compound dispenser of claim 12, wherein said attachment portion is further disposed to attach to a retraction tool handle of approximately 0.3 inches in cross section.
